(19) United States
(12) Patent Application Publication
(10) Pub. No.: US 2026/0220137 A1
(43) Pub. Date: Jul. 30, 2026

(54) Generating a Diverse Set of LLM Responses

(71) Applicant: GDM Holding LLC, Mountain View, CA (US)

(72) Inventors: Florian Nils Hartmann, Zurich (CH); Matthew Sharifi, Kilchberg (CH)

(21) Appl. No.: 19/041,742

(22) Filed: Jan. 30, 2025

(51) Int. Cl. G06F 16/2455; G06F 16/2458; G06F 40/284

(52) U.S. Cl. CPC G06F 16/2455; G06F 16/2474; G06F 40/284

(57) ABSTRACT

Systems and methods for generating a diverse set of LLM responses can include processing input data to generate a first response, updating a corpus of output responses based on the first response, and processing the input data utilizing a sampling method that biases a sampling of an additional sequence of tokens associated with the additional sequence of tokens based on a distance metric. The second sampling method selects additional tokens that are diverse from tokens contained in the corpus of output responses based on the distance metric. The systems and methods can generate a diverse set of responses based on the additional tokens.

### FIELD

The present disclosure relates generally to causing an artificial intelligence agent to generate diverse outputs. More particularly, the present disclosure relates to increasing semantic diversity among output responses of machine-learned models.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include processing input data using a sequence processing model to generate a first response as an output of the sequence processing model, wherein the first response includes a first sequence of tokens. The method can include updating, based on the first response, a corpus of output responses. The method can include processing the input data using the sequence processing model to generate an additional response as an additional output of the sequence processing model. The additional response can include an additional sequence of tokens. The sequence processing model can utilize a sampling method that biases a sampling of the additional sequence of tokens based on a distance metric, wherein the second sampling method selects one or more additional tokens that are diverse from tokens contained in the corpus of output responses based on the distance metric.

In some implementations the method includes updating, based on the additional response, the corpus of output responses.

In some implementations, the method includes providing the corpus of output responses as the additional output of the sequence processing model.

In some implementations, the distance metric includes a Levenshtein distance.

In some implementations, the sampling method that biases the sampling of the additional sequence of tokens includes applying a penalty to the candidate tokens based on the distance metric to modify a probability distribution for the candidate tokens, wherein the modified probability distribution decreases a probability of penalized candidate tokens being included in the additional response.

In some implementations, the penalized candidate tokens are associated with candidate tokens which fail to satisfy a distance metric threshold. In some implementations, the distance metric threshold is indicative of a level of semantic differences between the candidate tokens and the tokens contained in the corpus of output responses.

In some implementations, the one or more additional tokens that are diverse from tokens contained in the corpus of output responses includes one or more semantic differences.

In some implementations, the method includes analyzing the corpus of output responses to determine one or more fundamental tokens. In some implementations, the fundamental tokens are indicative of a probability distribution threshold.

In some implementations, the probability distribution threshold is associated with a level of correctness.

In some implementations, the additional response includes the one or more fundamental tokens.

In some implementations, the method includes generating another response concurrent to the first response as another output of the sequence processing model, wherein the other response includes another sequence of tokens. In some implementations, the method includes updating, based on the other response, the corpus of output responses in real-time.

In some implementations, the sequence processing model includes at least one of (i) a large language model (LLM) or (ii) a large multimodal model (LMM).

In some implementations, the one or more additional tokens includes text data.

In some implementations, the method includes training the sequence processing model using the one or more additional tokens that are diverse from the tokens contained in the corpus of output responses.

Another example aspect of the present disclosure is directed to a computing system. The system can include one or more processors and one or more non-transitory computer-readable media storing instructions that, when implemented, cause the computing system to perform operations. The operations can include processing input data using a sequence processing model to generate a first response as an output of the sequence processing model, wherein the first response includes a first sequence of tokens. The operations can include updating, based on the first response, a corpus of output responses. The operations can include processing the input data using the sequence processing model to generate an additional response as an additional output of the sequence processing model. The additional response can include an additional sequence of tokens. The sequence processing model can utilize a sampling method that biases a sampling of candidate tokens associated with the additional sequence of tokens based on a distance metric, wherein the second sampling method selects one or more additional tokens that are diverse from tokens contained in the corpus of output responses based on the distance metric.

In some implementations, the operations further include, updating, based on the additional response, the corpus of output responses.

In some implementations, the operations further include, providing the corpus of output responses as the additional output of the sequence processing model.

In some implementations, the distance metric includes a Levenshtein distance.

In some implementations, the operations further include analyzing the corpus of output responses to determine one or more fundamental tokens. In some implementations, the fundamental tokens are indicative of a probability distribution threshold.

Another example aspect of the present disclosure is directed to one or more non-transitory, computer-readable media storing instructions that, when implemented, cause one or more processors to perform operations. The operations include processing input data using a sequence processing model to generate a first response as an output of the sequence processing model, wherein the first response includes a first sequence of tokens. The operations include updating, based on the first response, a corpus of output responses. The operations include processing the input data using the sequence processing model to generate an additional response as an additional output of the sequence processing model. The additional response can include an additional sequence of tokens. The sequence processing model can utilize a sampling method that biases a sampling of candidate tokens associated with the additional sequence of tokens based on a distance metric, wherein the second sampling method selects one or more additional tokens that are diverse from tokens contained in the corpus of output responses based on the distance metric.

Other example aspects of the present disclosure are directed to other systems, methods, apparatuses, tangible non-transitory computer-readable media, and devices for performing functions described herein.

These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

For instance, aspects of the present disclosure can provide for a number of technical effects and benefits such as reducing the computational resources of machine-learned models, improving the information quality available to users, and efficiently decoding diverse outputs of machine-learned models in a single call as further described herein.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a block diagram of an example computing system according to example embodiments of the present disclosure;

FIG. 3 depicts a flow chart diagram of an example method to generate a diverse set of output responses according to example embodiments of the present disclosure;

FIG. 4A depicts an illustration of example input data according to example embodiments of the present disclosure;

FIG. 4B depicts an illustration of a plurality of example output responses according to embodiments of the present disclosure;

FIG. 5 depicts a block diagram of an example computing system according to example embodiments of the present disclosure;

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for improved generation of a diverse set of outputs from machine-learned models. More particularly, one challenge existing in the field of machine learning is that machine-learned models will often generate multiple output responses for a particular input (e.g., a user query or prompt) that are semantically similar to each other or otherwise duplicative. In some instances, consistency across multiple output responses may be desirable for a user. For example, when a machine learning model is used to generate an output (e.g., a response or completion) to the same input on multiple occasions, the model may typically generate outputs that are duplicative of each other, for example because the model simply decodes the most likely output values (e.g., tokens) conditioned on the input. In particular, traditional decoding methods for large language models (LLMs) use sampling techniques that are not implemented with the optimization goal of decoding semantically diverse responses. However, in some settings, it may be desirable to have multiple different outputs available for a given input. Thus, a technical problem in the field of machine learning is how to control machine learning models to generate multiple different outputs that are each high quality, yet still diverse from one another.

In view of the above challenge, the systems and methods described herein can provide for improved generation of a diverse set of output responses which are both likely and diverse by selectively biasing the sampling of an additional sequence of tokens associated with additional responses and selecting tokens that are diverse from the tokens contained in a corpus of output responses generated by the machine-learned model. In an implementation, the diverse tokens can be added to the corpus of output responses and the machine-learned model can be trained on the corpus of output responses to generate diverse output responses over time.

For example, in some implementations, input data associated with a user query can be processed by a machine-learned sequence processing model to generate one or more output responses. The initial response may include a sequence of tokens that are decoded using a greedy decoding or sampling which selects the most likely tokens to include in the sequence. The sequence of tokens can be added to a corpus of output responses. For instance, the corpus of output responses may include a plurality of candidate responses (e.g., K candidates) that are generally a likely output response to the input data.

In one example aspect, for instance, the model may generate additional output responses subsequently or in parallel. The model may again process the input data. However, during this processing, the model may bias the sampling of tokens by applying a penalty to tokens based on a distance metric indicating the similarity between two tokens or sequence of tokens. For instance, a Levenshtein distance can be used to determine a distance representative of similarities between the sequence of tokens contained in the corpus of output responses and additional candidate responses. Other measures of similarity (e.g., semantic similarity) can be used in addition or alternatively. The penalty can be selectively or consistently applied to tokens or sequences of tokens. For example, the model may revise lower-certainty tokens or sequences of tokens in additional output responses based on contextual aspects available in the output as a whole. In an embodiment, the penalty may be applied only to tokens or sequences of tokens that include a lower certainty due to an indication that these tokens or sequences of tokens are less fundamental to the output response compared to high certainty tokens. Additional tokens or sequences of tokens which are within a threshold distance (e.g. based on the distance metrics) of tokens within the corpus of output responses may be penalized to discourage the selection of the similar token in the additional output response. Additional tokens that exceed a threshold distance may be sampled free of any biases.

In an embodiment, tokens which are associated with a high certainty may also be penalized consistently with lower certainty tokens. For instance, tokens associated with a higher certainty may be fundamental to an output response due to, for example, a level of associated correctness (e.g., such as providing a correct name, etc.). However, higher certainty tokens, due to the high likelihood of being valid, may be penalized while maintaining a higher certainty compared to other candidate tokens if a penalty is applied consistently. This process of biased sampling can be repeated until K output responses are generated. Because the validity of a token may depend not only on preceding tokens but also subsequent tokens, the model can provide improved diversity and accuracy of output responses when considering the output as a whole.

In this manner, these additional tokens that are diverse from the tokens contained in the corpus of output responses provide an approach for generating semantically diverse output responses without penalizing “correct” or fundamental tokens. The diverse output from the token sequence processing model at each generation cycle provides alternative output response options to the user that include semantic differences. For instance, as the model generates an initial output response and additional output responses, the output of the model can indicate an increase in diversity associated with each token and/or the overall additional output responses. It can be desirable for multiple suggested responses to be provided as a response to a user query concurrently or consecutively in a manner that improves the diversity of the information available from the output without substantively altering accuracy.

Example aspects of the present disclosure provide systems and methods for improved diverse output response generation from machine-learned models. For instance, the systems and methods described herein can more efficiently diversify the information contained in output responses by penalizing tokens that are too closely related without increasing the computational costs over time associated with computing distances during decoding. For example, aspects of the present disclosure can provide a model that can generate the diverse output responses in a single call by distilling each additional output response generated back into the model. Furthermore, steering vectors can be applied to the model to encourage the model to generate different types of output responses.

In an aspect, the systems and methods described herein can provide for processing (e.g., by a computing system comprising one or more computing devices) input data using a machine-learned model sequence processing model to generate a first response as an output. The first response can include a sequence of tokens comprising one or more tokens. A token can be a portion of a larger response or answer produced by the sequence processing model. For instance, in some example implementations, the model can generate a response, such as a block of text or passage of text, comprising the plurality of tokens. The token can be any suitable token, such as, for example, a text token including text data, such as a word, phrase, sentence, letter, or other suitable delineation of text.

In some implementations, the output can be obtained from a machine-learned token generation model. The machine-learned token generation model can be any suitable model. For instance, in some implementations, an agent system (e.g., an “artificial intelligence agent” or “AI agent”) can employ one or more machine-learned models to generate outputs responsive to queries from users. As one example, an agent system can be or can include a computing system including one or more machine-learned token generation models, where the computing system is configured to receive an input from a user device or calling device and provide an output including a plurality of tokens that are responsive to the input to the user device or calling device. As one example, the plurality of tokens can be or can include text data such as words, and/or the plurality of tokens can collectively form a passage or block of text that is displayed to the user. The plurality of tokens can, for instance, collectively describe an answer or response to the user's input. Furthermore, in some implementations, the plurality of tokens can be or can include (e.g., or can be converted to) spoken language data such as audio data that can be spoken to the user. In some implementations, the machine-learned token generation model(s) can output values, such as confidence scores or certainty scores, tonality scores, and/or other suitable scores and/or values, which are respectively associated with the plurality of tokens.

In some implementations, the agent system can be or can implement a multi-modal agent (e.g., a multi-modal artificial intelligence agent). For instance, a multi-modal agent can process inputs from one or more data modalities. In some implementations, the agent system can be implemented as a “situated agent”. The term situated agent refers to a setting in which the agent system shares one or more perceptual inputs with a human user. For example, the situated agent can receive and process various data inputs, including video, audio, and/or textual data which are also observable by the human user. The agent system can process these inputs to generate responses that are contextually-relevant for the user's physical or digital environment, for example enabling the agent system to generate dialogue or other responses or outputs which assist the user in understanding and/or navigating the environment.

In an aspect, the systems and methods described herein can provide updating (e.g., by the computing system), based on the first response, a corpus of output responses. The corpus of output responses can include a body of text data that the sequence processing model is trained on. For instance, in some implementations, the systems and methods described herein can update the corpus of output responses by adding the first response and additional responses respective to a plurality of tokens in an output to the corpus. The corpus can be iteratively updated and accessible to the sequence processing model during each decoding cycle of output responses.

As one example, in some implementations, sequence of tokens can be associated with a certainty score or confidence score associated with a respective token. The certainty score can be representative of a certainty of the token generation model associated with the token, such as, for example, a certainty that the token is correct, a certainty that the token will be included in the final output, a certainty that the token is a best choice among a plurality of possible choices, or other certainty that is generally reflective of a confidence in the token as output. For example, in some implementations, the token generation model is configured to select each token from a plurality of candidate tokens based on a probability distribution associated with the plurality of candidate tokens. For instance, the model can select a token having a highest probability. The certainty score can be determined based on the probability distribution associated with the plurality of candidate tokens. For example, in some implementations, the certainty score can be the probability of the probability distribution that is associated with the selected token from the plurality of candidate tokens. Tokens with higher probabilities can therefore have a higher likelihood and/or tokens with lower probabilities can therefore have a lower likelihood of being decoded into the output response generated by the sequence processing model. Still further, in some implementations, a model other than the token generation model (e.g., an adversarial model) may generate the certainty score.

As another example, in some implementations, the machine-learned token generation model can be or can include a sequence processing model. The sequence processing model can be configured to individually generate a sequence of tokens. For instance, the output at each iteration or update cycle can be or can include the plurality (e.g., sequence) of tokens. Examples of a sequence processing model include, but are not limited to, a large language model (LLM) or a large multimodal model (LMM). For instance, the sequence processing model may generate tokens in a sequential manner. The sequence processing model may not provide a fixed-length block of tokens but rather generate each token as evaluation of the model progresses. The EOS token may signal the model to cease generation of tokens. The model's output may have fewer tokens than a maximum length, for instance. Iterations of the sequence processing model (e.g., update cycles) can refer to multiple “passes” over the sequence of tokens, where tokens in the sequence from one update cycle and/or their respective rendering values are provided as input in a subsequent update cycle to improve the model's understanding about the entire sequence of tokens at the subsequent update cycle.

In an aspect, the systems and methods described herein can provide for processing (e.g., by the computing system) the input data to generate one or more additional responses as additional outputs of the sequence processing model. The additional responses can include an additional sequence of tokens. To generate the additional response, the sequence processing model can utilize a sampling method that biases the sampling of the additional sequence of tokens. For example, the sequence processing model can select one or more additional tokens that are diverse from the tokens contained in the corpus of output responses using a distance metric. The sequence processing model can compute a distance between the first sequence of tokens associated with the first output response and additional (e.g., candidate) sequences of tokens associated with additional responses. For tokens or sequences of tokens that have a distance below a threshold distance, the sequence processing model can apply a penalty to further decrease the certainty score of the penalized tokens. For instance, the penalty may modify the probability distribution of the penalized tokens such that the penalized tokens have a lower probability of being selected within the additional sequence of tokens associated with the additional output responses. In this manner, the generation of diverse output responses can occur during decoding of tokens from the token generation model reducing complexity and computational costs.

In an aspect, the systems and methods described herein can provide for updating, (e.g., by the computing system) based on the additional responses, the corpus of output responses. For instance, the sequence processing model can add or store the additional output responses to the corpus of output responses. A user interface can define token positions that are configured to receive, store, and/or otherwise accept values or data from the token(s) of the output responses. As one example, the token positions may receive characters or words defined by the token(s). As another example, the token positions may be placeholder elements in the user interface. For instance, in some implementations, generating the user interface can include replacing the placeholder elements with values defined by the token(s) of the output responses within the corpus of output responses. In some implementations, generating the user interface can include generating data that is implementable by a computing system to cause display of the user interface. Such data can include, for example, extended Markup Language (XML) data, Hypertext Markup Language (HTML) data, text document data, slide show data, spreadsheet data, and/or any other suitable data.

In some implementations, the systems and methods described herein can provide for analyzing (e.g., by the computing system) the corpus of output responses to determine one or more fundamental tokens. As used herein, “fundamental tokens” are tokens within an output response identified through a computational process as being relevant to the core informational content of the response, thus contributing to the meaning or accuracy of the response within the context established by the input data and the corpus of output responses. In some embodiments, the computational process may comprise a probabilistic analysis based on the output of the sequence processing model. In such embodiments, tokens having a probability exceeding a predetermined or dynamically adjusted threshold may be considered relevant. Alternatively or in addition, the computational process may comprise a natural language processing analysis of the token's relationship to other tokens in the response. In such cases, tokens identified as having a direct syntactic or semantic relationship to key elements of the input or the corpus of output responses are considered relevant. As a further alternative or addition, the computational process may comprise an analysis of the token's contribution to the factual accuracy of the response. Here, tokens that are verifiable through external knowledge sources or through logical inference based on the input data and the corpus of output responses are considered relevant.

For instance, the corpus of output responses may include the first response output and additional response outputs that indicate consistent tokens. Consistent tokens that appear across output responses contained in the corpus may be associated with high certainty tokens and indicate that the tokens are fundamental to the output response. For example, fundamental tokens can be associated with a word such as “yes” to a binary (e.g., yes/no” question. As such each of the output responses may include a fundamental token that begins with “yes”, “yeah”, “yep”, etc. to indicate an affirmative response to the user query. In an embodiment, fundamental tokens may be indicative of a high probability distribution that are likely to be included within the additional output responses irrespective of sampling bias applied during decoding. As another example, fundamental tokens can be associated with factual information that is directly responsive to a particular query. For example, tokens corresponding to the words “George Washington” are highly useful, if not strictly necessary, to provide an accurate answer to the query “Who was the first president of the United States?” Therefore, some example embodiments can include identifying certain fundamental tokens and excluding those tokens from the penalization techniques described herein, thereby enabling the model to create diverse, yet factually grounded or otherwise accurate responses.

Another example aspect of the present disclosure can provide for training (e.g., by the computing system) the sequence processing model using the additional output responses that are diverse from the first response output. For instance, the additional diverse output responses can be distilled back into the sequence processing model at each decoding cycle such that the sequence processing model can be trained to generate diverse output responses by caching distance metrics computed between previous tokens in previous sequences. The cached distance metric can be used to more efficiently apply penalties where needed. Furthermore, the sequence processing model may be trained to avoid penalizing fundamental tokens which are consistent across output responses contained in the corpus. In another aspect, the diverse responses can be used to generate preference pairs or preference tuples for which human preference labels can be collected in a reinforcement learning via human feedback (RLHF) training scheme.

In some implementations, the systems and methods described herein can provide for rendering the token as well as the one or more additional tokens that represent an alternative to the token in the output of the machine-learned token generation model. For instance, the additional sequence of tokens may be displayed concurrently with the first sequence of tokens, in response to a user command (e.g., by requesting a new response), as alternatives (e.g., in a stacked arrangement or similar adjacent arrangement), or in other suitable manner. For example, in some implementations, formatting characteristics such as a size of the tokens, and a rendering value respective to each token can represent a certainty score associated with each token. In this manner, a more certain sequence of tokens can be displayed at a larger size and adjacent to its alternatives, which are displayed with a smaller size. In some implementations, the systems and methods described herein may determine to render the alternate tokens based on some ratio or relationship (e.g., distance) of the first sequence of tokens and the additional sequences of tokens.

In an aspect, the systems and methods described herein can provide for causing display of the user interface by the computing system. As one example, in some implementations, causing display of the user interface by the computing system can include communicating the user interface (e.g., data descriptive of the user interface) to a display device. The display device may be provided at the computing system and/or an external computing system. For example, in some implementations, communicating the user interface can include communicating the user interface over one or more communication networks.

Furthermore, in some implementations causing display of the user interface can provide for rendering one or more user interface elements via the display device based on the user interface. The display device can be configured to render and/or display the user interface (e.g., to a user or other observer). For instance, the display device can control one or more display elements (e.g., pixels) based on the user interface including the rendered token element such that the user interface is presented to the user. Any suitable method of displaying the user interface can be employed in accordance with the present disclosure. As one example, a graphics processing unit (GPU) or similar computing device can compute a matrix of pixel intensities that represent the user interface and provide the matrix of pixel intensities to a display (e.g., a screen or monitor) configured to interpret the matrix of pixel intensities and light up corresponding pixels in the display in accordance with the matrix of pixel intensities.

Example aspects of the present disclosure can provide for a number of technical effects and benefits, including improvements to computing technology. As one example, providing a diverse set of output responses in response to a user query can improve diversity in training samples for training machine-learned models to generate diverse responses. For instance, the model can readily interpret the distance metrics between sequences of tokens and be trained to diversify output responses while maintaining accuracy within the response. In this manner, the user is not required to iteratively request regeneration of output responses, for example, due to duplicative or redundant responses produced by the model. This, in turn, can reduce the computational resources used by the model.

As another example, providing a diverse set of output responses can improve the information quality available in the user interface. This, in turn, can provide for better quality of comparable output responses to be conveyed sooner to the user, thereby providing a reduction in computing resources needed to receive, generate, render, and/or display additional output responses via the user interface. In applications with limited network connection, such as, for example, in high network traffic areas, these time and computational savings can significantly improve usability and user experience of the systems and methods according to the present disclosure.

As yet another example, aspects of the present disclosure enables new modes of operation of a computing device. For instance, aspects of the present disclosure provide for diverse outputs at progressive decoding cycles to be included independent from the model's token generation processes. This information can be readily conveyed to the user. For instance, while tokens from a first response output are decoded, additional output response tokens may also be decoded over subsequent generation cycles which offer a more robust selection of output responses for the user to choose from. This information may otherwise have been either unavailable to the user or could not be conveyed in such a manner due to the computational cost associated with computing distance metrics for large values of candidate tokens. According to example aspects of the present disclosure, however, by distilling diverse output responses back into the and subsequently providing cached distance metrics to the machine-learned sequence processing model, the computing system can be enabled to more efficiently decode diverse outputs in a single call, rather than requiring that the output be decoded and then diversified.

The aforementioned example aspects of the present disclosure therefore provide that a computing device can be enabled to alter or bias decoding of sequences of tokens in response to detecting semantic similarities. This can conserve significant otherwise wasted computing resources associated with repetitive decoding responses that are no more diverse than the preceding response and/or receiving a new prompt or user query to facilitate the generation of a diverse response.

With reference now to the Figures, example embodiments of the present disclosure will be discussed in further detail.

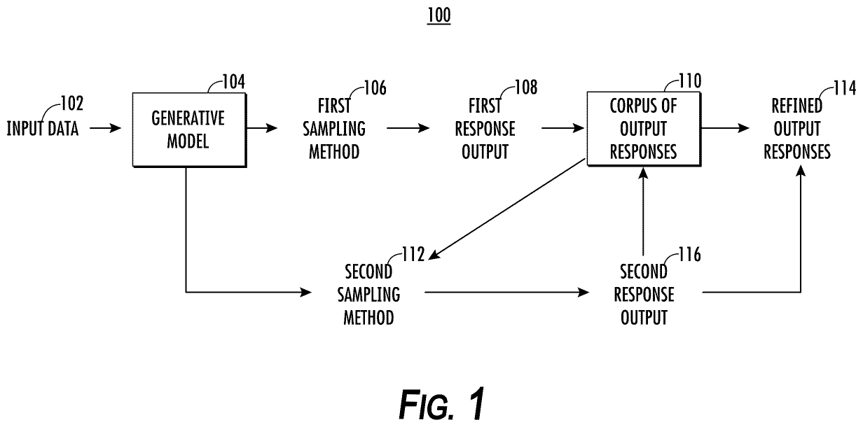

FIG. 1 depicts a block diagram of an example computing system 100 according to example embodiments of the present disclosure. In some implementations, the computing system is configured to receive, and/or obtain, input data 102 descriptive of a user prompt that indicates an anticipated response to a statement and/or question and, as a result of receipt of the input data 102, generate, determine, and/or provide one or more refined output responses 114 that includes a sequence of tokens determined to be responsive to the input data 102. Thus, in some implementations, the computing system 100 can include a generative model 104 that is operable to generate a prediction output descriptive of a first response output 108 and a second response output 116 that may be semantically diverse from each other.

In particular, the computing system 100 can obtain the input data 102 from a user computing device. The input data 102 can include text data, image data, audio data, latent encoding data, multimodal data, and/or other data. The input data 102 may include a request for a plurality of different responses to the same question or statement (e.g., draft responses, alternative response options, etc.).

The computing system 100 can process the input data 102 to generate the first response output 106. The first response output 106 may include a sequence of tokens obtained from a corpus of tokens available to a generative model 104. The first sequence of tokens may be determined using a first sampling method 106 that employs a semantic analysis to determine semantic relationships between tokens within the corpus of tokens and selects tokens to include in the first output response 108 that indicate a highest probability or likelihood of being used together within similar context of the input data 102. The first sampling method 106 may include a greedy sampling, random sampling, top-K, beam searching, or other sampling techniques which selects the most probable token for the token sequence.

The generative model 104 can process the input data 102 using the first sampling method 106 to generate the first response output 108. The generative model 106 can include an autoregressive language model. The generative model 106 may include an encoder to encode the input data 102 and a decoder for employing sampling methods to generate the output sequence of tokens contained in the output responses 110.

Based on the first output response 108, a corpus of output responses 110 may be updated to include the first decoded response to the input data 102. The corpus of output responses 110 may include a collection of response output data (e.g., token sequences) generated in response to the input data 102. The generative model 104 may concurrently and/or sequentially generate a second response output 116 (e.g., additional token sequences) based on the token sequences contained in the corpus of output responses 110 using a second sampling method 112. The second sampling method 112 may cause the second response output 116 to be semantically diverse from the first response output 108 and other token sequences contained in the corpus of output responses 110.

For example, the generative model 104 may employ the second sampling method 112 to decode the second response output 116 such that sample candidate tokens from the corpus of tokens that are semantically diverse are selected to be included in the second response output 116. The second sampling method 112 may apply penalties to tokens that are determined to be semantically similar to tokens or token sequences contained in the corpus of output responses 110. The penalties may be based on a distance metric that indicates a level of similarity or closeness of two tokens or token sequences. The distance metric between candidate tokens for the second response output 116 and tokens contained in the corpus of output responses 110 can be determined during each decoding step by the computing system 100. Example distance metrics may be determined using Levenshtein distance calculations, Trigram Comparisons, Jaro-Winkler Algorithm calculations, latent space token embeddings, normalized distances, etc.

By way of example, a Levenshtein distance metric between two strings a,b (of length |a| and |b| respectively) for a set of given tokens is given by lev (a,b) where

$$lev ( a , b ) = \{ \begin{matrix}\vert a \vert & if \vert b \vert = 0 , \\ \vert b \vert & if \vert a \vert = 0 , \\ lev ( tail ( a ) , tail ( b ) ) & if head ( a ) = head ( b ) , \\ 1 + min \{ \begin{matrix}lev ( tail ( a ) , b ) ) \\ lev ( a , tail ( b ) ) \\ lev ( tail ( a ) , tail ( b ) )\end{matrix} & otherwise\end{matrix}$$

where the tail of some string x is a string of all but the first character of x (i.e. tail(x₀ x₁ . . . xₙ)=x₁ x₂ . . . xₙ), and head (x) is the first character of x (i.e. head(x₀ x₁ . . . xₙ)=x₀. Either the notation x[n] or xₙ is used to refer the nth character of the string x, counting from 0, thus head (x)=x₀=x[0]. The first element in the minimum corresponds to deletion (from a to b), the second to insertion and the third to replacement.

For instance, the Levenshtein distance between the tokens “kitten” and “sitting” is 3, since the following 3 edits change one into the other, and there is no way to do it with fewer than 3 edits: kitten→sitten (substitution of “s” for “k”), sitten→sittin (substitution of “i” for “e”), sittin→sitting (insertion of “g” at the end). An example of a deletion can be seen with “uninformed” and “uniformed” which has a distance of 1: uninformed→uniformed (deletion of “n”).

Tokens that fail to satisfy a distance metric threshold (e.g., less than 3, 4, etc.) may be penalized using the second sampling method 112 as being too semantically similar to tokens included in token sequences contained in the corpus of output responses 110. The penalty may modify the probability distribution of candidate tokens which may cause the penalized candidate token to appear less likely or probable of being used together within a similar context. For instance, the generative model 104 can select a token to include in a sequence of tokens comprised in the second response output 116. The selected tokens included in the second response output 116 can include candidate tokens with the highest probability of being used together within a similar context after penalties have been applied (e.g., via the second sampling method 112).

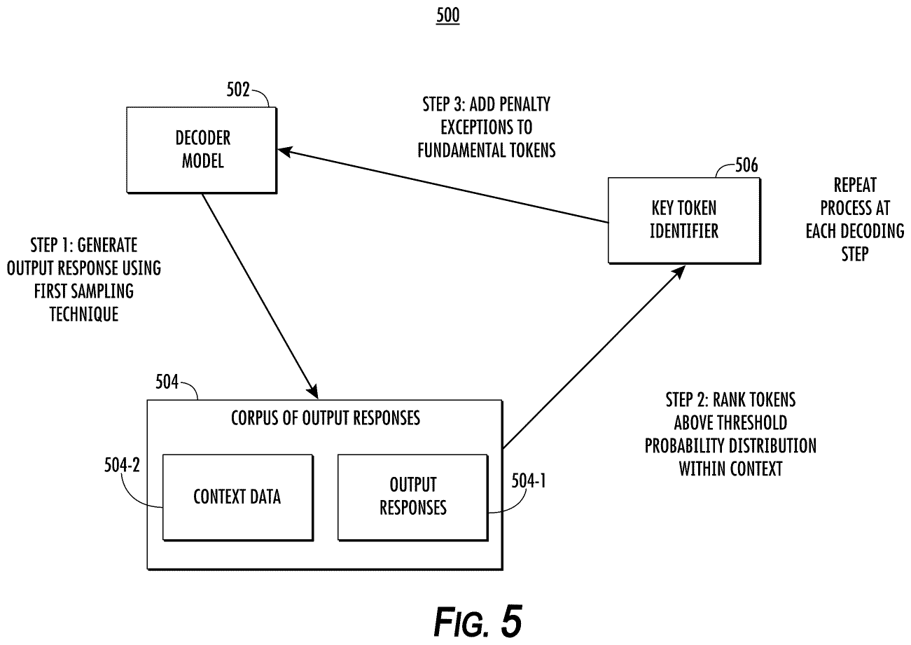

For example, a certainty score can be determined for each token based on the modified (e.g., penalized) probability distribution. The certainty score can be an updated or modified probability distribution associated with the selected token from the plurality of candidate tokens based on the penalties. Once penalties have been applied, more diverse tokens with higher probabilities can have a higher likelihood and/or less diverse tokens with lower probabilities can therefore have a lower likelihood of being decoded into the second response output 116. In an embodiment, tokens or sequences of tokens which are fundamental (e.g., correct answers, names, locations, etc.) to responding to input data 102 may be exempt from being penalized. An example of fundamental tokens is further described with reference to FIG. 5.

Responsive to applying penalties to candidates tokens, the second response output 116 may be generated. The corpus of output responses 110 may be updated based on the second response output 116. A set of refined output responses 114 can be generated based on the corpus of output responses 110. The set of refined out responses 114 may include a plurality of response options or drafts responsive to the input data 102. The refined output response 114 can be provided back to the user.

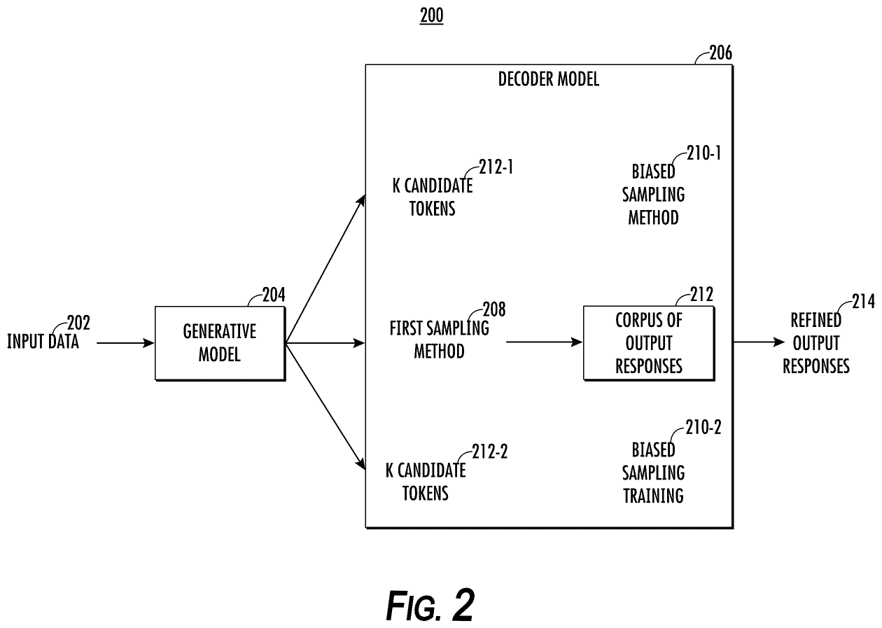

FIG. 2 is a block diagram of an example computing system 200 according to example embodiments of the present disclosure. The computing system 200 is similar to the computing system 100 of FIG. 1 except that computing system 200 further includes a decoder model 208, biased sampling methods 210-1, 210-2, and candidate tokens 212-1, 212-2.

In particular, the computing system 200 can obtain input data 202 from a user computing device. The input data 202 can include text data, image data, audio data, latent encoding data, multimodal data, and/or other data. The input data 202 may include a request for a plurality of different responses to the same question or statement (e.g., draft responses, alternative response options, etc.).

The computing system 200 can process the input data 202 to generate a set of refined output responses 214. The set of refined output responses 214 may include a set of output responses based on sequences of tokens contained in the corpus of output responses 212. The sequences of tokens may be decoded using a first sampling method 208 and biased sampling methods 210-1, 210-2.

For example, the generative model 204 can process the input data 202 and a first output response may be generated using the first sampling method 208 which selects tokens to include in the sequence of tokens associated with first output response. Responsive to the first sampling method 208, the corpus of output responses 212 may be updated by adding the first output response to the corpus of output responses 212. In some implementations, the corpus of output responses 212 can be updated by processing the input data 202 with the generative model 204 and decoding the sequence of tokens associated with the output response with the decoder model 206 and/or any other machine-learned model.

The decoder model 206 may be separate from, part of, or the same as the generative model 204. The decoder model 206 may include a natural language processing model (e.g., an autoregressive language model) tuned to implement various sampling methods to decode output response. The first sampling method 208 may employ a semantic analysis to determine semantic relationships between tokens within the corpus of tokens and selects tokens to include in a first sequence of tokens that indicate a highest probability or likelihood of being used together within similar context. The first sampling method 208 may include a greedy sampling, random sampling, top-K, beam searching, or other sampling techniques which selects the most probable token for the token sequence.

Based on the first sampling method 208, the corpus of output responses 212 may be updated to include a first output response responsive to the input data 202. The decoder model 206 may, at each decoding step for additional output responses (e.g., draft responses), analyze the corpus of output responses 212 to determine a distance metric between the candidate tokens 212-1, 212-2 and tokens contained in the corpus of output responses 212.

For example, the decoder model 206 may parse the candidate tokens 210-1, 210-2 that are output by the generative model 204 and generate distance metrics between the candidate tokens 210-1, 210-2 and the tokens contained in the corpus of output responses 212. For instance, the decoder model 206 may, in parallel or sequentially, determine a distance between a first token associated with a first sequence of tokens contained in the corpus of output responses 212 and an additional candidate token of candidate tokens 212-1.

Based on the distance metric, the decoder model 206 may employ a biased sampling method 210-1. The biased sampling method may include a modified first sampling method 208. For instance, the biased sampling method 210-1 may apply penalties to tokens or token sequences that fail to satisfy a distance metric threshold. By way of example, the decoder model 206 may be configured to enforce a distance metric threshold which applies penalties to candidate tokens 212-1 determined to have a Levenshtein distance of 2 or fewer from tokens contained in the corpus of output responses 212. The penalty may modify a probability distribution over the candidate tokens 212-1 during decoding. For instance, candidate tokens 212-1 which are highly likely to be decoded in an output response may be penalized for failing to satisfy the distance metric threshold and consequently become less likely to be decoded in the output response. Accordingly, the biased sampling method 210-1 may penalize a decoded output response which is too semantically similar to output responses already contained in the corpus of output responses 212. This encourages the computing system 200 to decode diverse outputs.

Based on the biased sampling method 210-1, an additional output response (e.g., associated with the candidate tokens 212-1) may be generated. The additional output response may be added to the corpus of output responses 212.

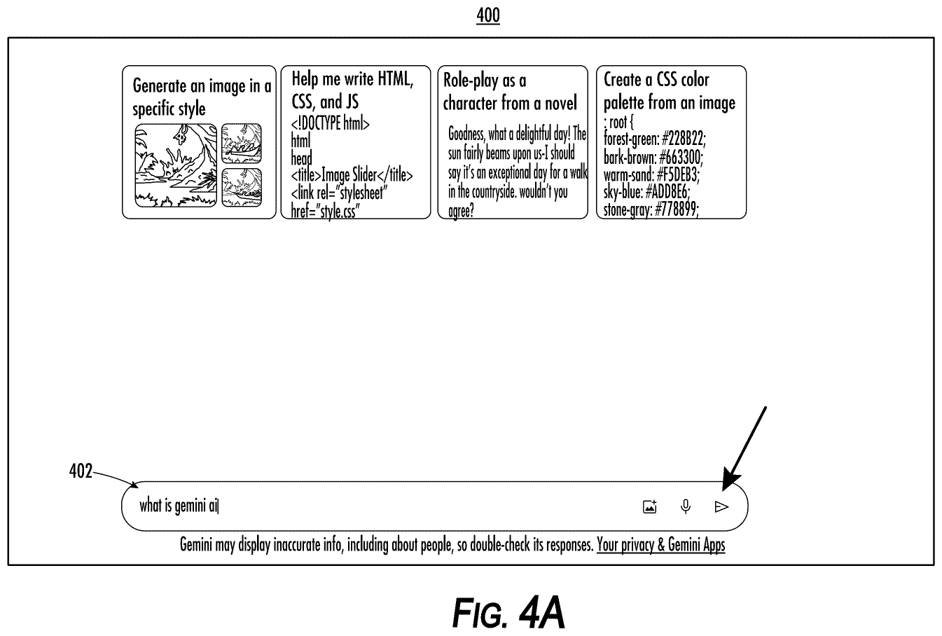

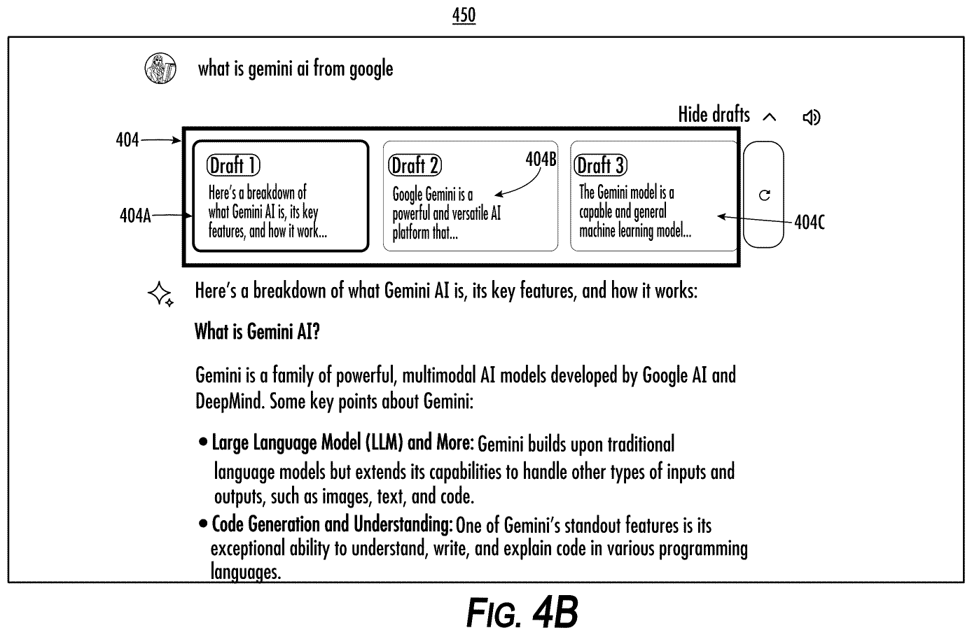

In an embodiment, the generative model 204 can generate a plurality of output responses concurrently using the first sampling method 208, the second sampling method 210-1, 210-2, and/or other sampling methods. For instance, the generative model 204 may generate another output response concurrent to the first output response in order to provide a plurality of refined output responses 214 as a set of draft responses. An example of draft responses is further described with reference to FIGS. 4A-4B.

By way of example, the generative model 204 may process the input data 202 and generate a first output response and another output response concurrently using the first sampling method 208, second sampling method 210-1, etc. For instance, the first output response may be partially decoded while another output response is decoded concurrently. Based on the partially decoded response which include one or more sequences of tokens, the generative model 204 may begin decoding the remainder of the first output response and/or the other output response using the biased sampling methods 210-1, 210-2. For example, as the first output response is being decoded, the selected tokens of the partial response may be added to the corpus of output responses 212.

In an embodiment, the decoder model 206 may monitor the corpus of output responses 212 to detect token sequences as they are being decoded and in real-time begin decoding another output response concurrently using the biased sampling methods 210-1, 210-2 based on the tokens associated with the partially decoded first output response. For instance, the corpus of output responses 212 may be updated after a threshold number of k candidate tokens 212-1, 212-2 have been selected to ensure sufficient context for concurrent or subsequent decoding steps using the second sampling methods 210-1, 210-2. In this manner, the corpus of output responses 212 may be updated in real-time and concurrently based on a plurality of output responses while maintaining semantic diversity from each other.

In an embodiment, the distance metric for the candidate tokens 212-1 may be cached and used to determine a distance between the additional output response (e.g. associated with the candidate tokens 212-1) and another candidate token of the candidate tokens 212-2. For instance, the candidate tokens 212-1 and the candidate tokens 212-2 may be associated with respective output responses (e.g., different draft responses) generated in response to the input data 202 in addition to the first output response.

Responsive to the cached distance metric associated with the additional output response (e.g., candidate tokens 212-1) contained in the corpus of output responses 212, the decoder model 206 may determine a second distance metric between the candidate tokens 212-2 and the tokens associated with the additional output response. Based on comparing the second distance metric associated with the candidate tokens 212-2 to the distance metric threshold, the decoder model 206 may employ the biased sampling method 210-2 to penalize tokens of the candidate tokens 212-2 which fail to satisfy the distance metric threshold. Accordingly, the decoder model 206 may iteratively or continuously generate output responses that are diverse from previously or concurrently decoded outputs.

While examples herein describe a static distance metric, the present disclosure is not limited to such embodiment. The distance metric may be dynamically adjusted at each decoding step within a range to provide flexibility in the penalty scheme and discourage diversity which yields inaccurate or inarticulable refined output responses 214. Moreover, steering vectors may be used to encourage the decoder model 206 to generate outputs that are diverse from each other.

Based on the biased sampling methods 210-1 and 210-2, the corpus of output responses 212 may be updated and a plurality of refined output responses 214 may be generated and provided to the user.

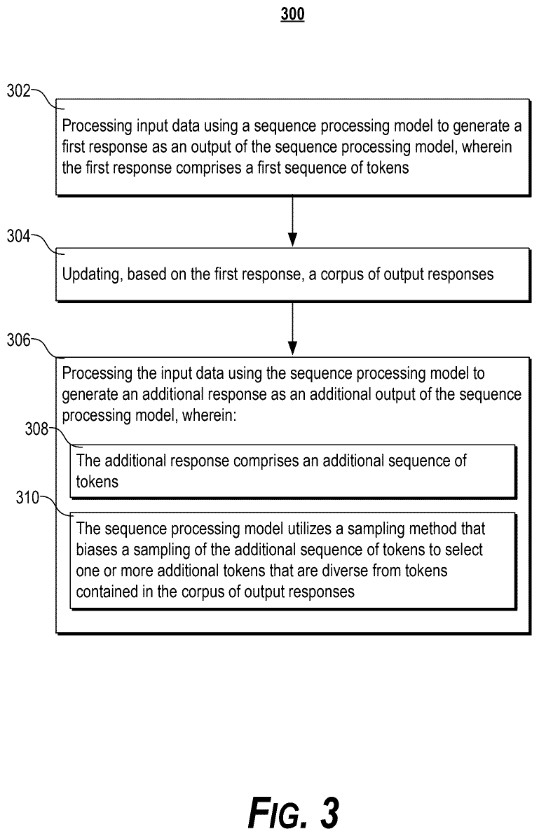

FIG. 3 depicts a flowchart of an example method to generate a diverse set of output responses according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can process input data using a sequence processing model to generate a first response as an output of the sequence processing model. The first response can include a first sequence of tokens. For example, the input data can include text data, image data, audio data, latent encoding data, multimodal data, and/or other data. The input data may include a request for a plurality of different responses to the same question or statement (e.g., draft responses, alternative response options, etc.). The input data can be obtained from a user computing device associated with a user.

The computing system can include a sequence processing model configured to process the input data to generate the first response output. The first response output may include a sequence of tokens obtained from a corpus of tokens available to a large language model. The first sequence of tokens may be determined using a first sampling method that employs a semantic analysis to determine semantic relationships between tokens within the corpus of tokens and selects tokens to include in the first output response that indicate a highest probability or likelihood of being used together within similar context of the input data. The first sampling method may include greedy sampling, random sampling, top-K, beam search, or other sampling techniques.

At 304, the computing system can update, based on the first response, a corpus of output responses. For example, based on the first output response, a corpus of output responses may be updated to include the first response decoded in response to the input data. The corpus of output responses may include a collection of response output data (e.g., token sequences) generated in response to the input data.

In an embodiment, the first response may be added to the corpus of output responses at each decoding step. For instance, the computing system may generate sequentially and/or concurrently a plurality of output responses in response to the input data.

At 306, the computing system can process the input data using the sequence processing model to generate an additional response as an additional output of the sequence processing model. For example, the large language model may concurrently and/or sequentially generate a second response output (e.g., additional token sequences) based on the token sequences contained in the corpus of output responses using a second sampling method.

At 308, the additional response can include an additional sequence of tokens. For example, the additional response may be associated with candidate tokens that were selected to be included in a sequence of tokens representative of the additional response. In an embodiment, the sequence of tokens associated with the additional response may be selected using a second sampling method.

At 310, the sequence processing model can utilize a sampling method that biases a sampling of the additional sequence of tokens to select one or more additional tokens that are diverse from tokens contained in the corpus of output responses. For example, the second sampling method may cause the additional response to be semantically diverse from the first response and other responses contained in the corpus of output responses.

In an embodiment, the sequence processing model may analyze the corpus of output responses to determine a distance metric between the candidate tokens associated with the additional response and tokens associated with the first response contained in the corpus of output responses. For example, the sequence processing model may parse the candidate tokens and generate distance metrics between the candidate tokens and the tokens associated with the first response contained in the corpus of output responses.

In an embodiment, the sequence processing model may, in parallel or sequentially, determine a distance between a first token within a first sequence of tokens contained in the corpus of output responses and an additional candidate token associated with the additional response. Based on the distance metric, the sequence processing model may employ a biased sampling method.

In an embodiment, the biased sampling method may include a modified first sampling method. For instance, the biased sampling method may apply penalties to tokens or token sequences that fail to satisfy a distance metric threshold. The penalty may modify a probability distribution over the candidate tokens of the additional response during decoding. For instance, candidate tokens of the additional response which are highly likely to be decoded in the additional response may be penalized for failing to satisfy the distance metric threshold and consequently become less likely to be decoded in the additional response.

Accordingly, the biased sampling method may penalize a decoded additional response which is too semantically similar to the first response causing the sequence processing model to select additional tokens that are diverse from tokens contained in the corpus of output responses. Based on the biased sampling method, an additional response (e.g., associated with the candidate tokens) may be generated. The additional response may be added to the corpus of output responses.

In an embodiment, the distance metric for the candidate tokens may be cached and used to determine a distance between the additional output response (e.g. associated with the candidate tokens) and another candidate token of the candidate tokens. For instance, the candidate tokens associated with the additional response and another candidate token may be associated with different draft responses that are generated in response to the input data in addition to the first response.

FIG. 4A depicts an illustration of an example input data according to example embodiments of the present disclosure. In particular FIG. 4A depicts an example user input 402. For example, the user input 402 may be a question provided via a user interface of a user computing device and processed to generate one or more responses. The input data 402 may be encoded into a format that may be processed by a generative model.

FIG. 4B depicts an illustration of a plurality of example output responses according to embodiments of the present disclosure. In particular, FIG. 4B depicts an example output response 404 generated in response to the input data 402. For example, a generative model may receive the encoded input data 402 and generate a first response 404A and additional responses 404B-C in response to the input data 402.

In an embodiment, the additional responses 404B-C may be generated sequentially and/or concurrently to the first response 404A. For instance, as depicted the first response 404A and the additional responses 404B-C may be respective drafts or alternative options that were each generated in response to the input data 402. The first response 404A and the additional responses 404B-C may be semantically diverse from each other to provide the user with alternative response options which each include correct information responsive to the input data 402 but are diverse in articulating the response.

FIG. 5 depicts a block diagram of an example computing system 500 according to example embodiments of the present disclosure. In particular, the computing system 500 can analyze the tokens contained in a corpus of output responses 504 to iteratively determine fundamental tokens which should be exempt from being penalized by a decoder model 502 at subsequent decoding steps.

For example, a decoder model 502 (e.g., large language model tuned for decoding diverse outputs) can generate output responses 504-1 based on input data provided to the computing system 500. The output responses 504-1 may include a plurality of tokens and/or token sequences. The output responses 504-1 including the plurality of tokens and/or token sequences can then be added to a corpus of output responses 504. The corpus of output responses 804 may store a collection of output responses 504-1 generated in response to input data. In an embodiment, the decoder model 502 may also update the corpus of output responses 504 to include context data 504-2. Context data 504-2 may include relevant data or context used by the computing system 500 to determine candidate tokens to include in the output responses 504-1. Accordingly, the corpus of output responses 504 may include contextual information associated with each of the output responses 504-1 such that a key token identifier 506 may determine tokens and/or token sequences that are fundamental to output responses 504-1 generated in response to the input data.

At each decoding step for output responses 504-1 added to the corpus of output responses 504, a key token identifier may analyze the corpus of output responses 504 to determine fundamental tokens that may qualify for a penalty exemption for additional output responses 504-1. The key token identifier 506 can include an autoregressive language model.

The key token identifier 506 may determine fundamental tokens included in the corpus of output response 504-1 based on respective probability distribution for each token and/or sequence of tokens associated with the output responses 504-1. For example, tokens and/or token sequences may be ranked based on a level of confidence (e.g., probability distribution) that the respective token/sequence of tokens may be included in an output response 504-1 within the indicated context data 504-2.

In an embodiment, the key token identifier 506 may determine fundamental tokens and/or sequences of tokens based on probability distributions which exceed a probability distribution threshold. For instance, tokens associated with correct names, locations, numbers, etc. may be associated with higher probability distributions than other tokens due to the high likelihood that a correct name, location, number etc. would be included in an output response 504-1 generated in response to input data that inquires about such name, location, number, etc. Accordingly, the key token identifier 506 may determine fundamental tokens which should be exempt from penalties by the decoder model 502 at subsequent decoding steps for additional output responses 504-1.

For example, the decoder model 502 may employ a biased sampling method to generate additional output responses 504-1 that are semantically diverse from the output responses 504-1 contained in the corpus of output responses 504. The biased sampling method may penalize tokens and/or sequences of tokens that are too similar to tokens or sequences of tokens contained in the corpus of output responses 504. The key token identifier 506 exempts fundamental tokens from penalty such that the decoder model 502 is not encouraged to decode inaccurate or irrelevant output responses 504-1.

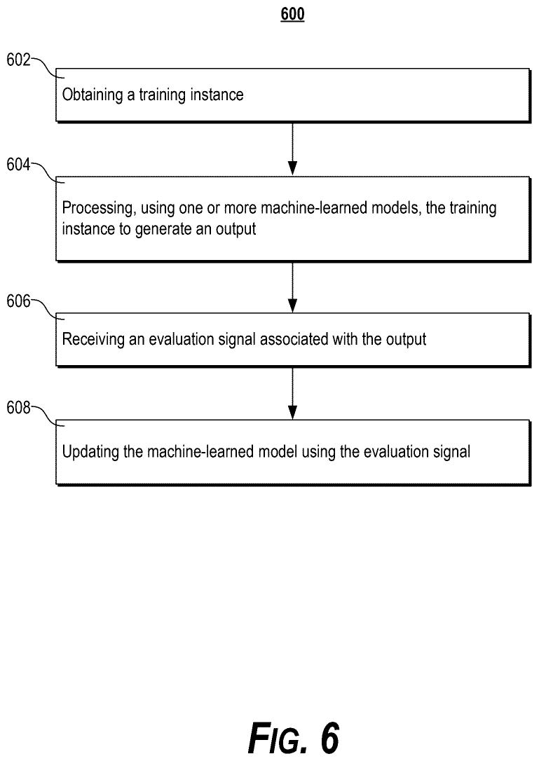

FIG. 6 depicts a flowchart of a method 600 for training one or more machine-learned models according to aspects of the present disclosure. For instance, an example machine-learned model can include a decoder model.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types.

In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 600 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 600 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

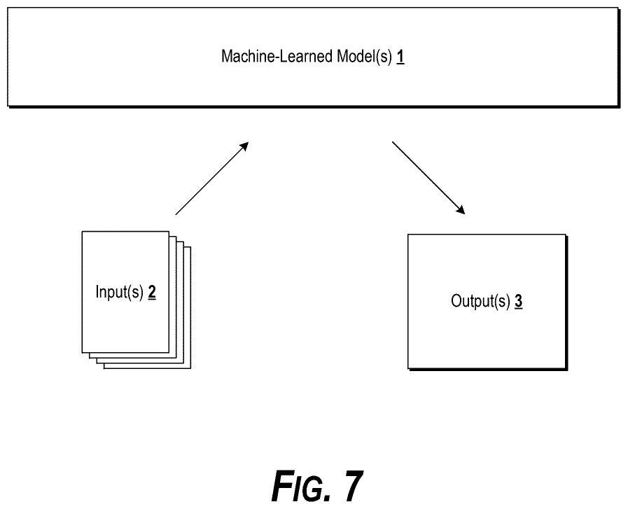

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of decoder models 206, etc. Although various features, variations, and implementations described below are described with respect to machine-learned model(s) 1, it is to be understood that such features, variations, and implementations are to be understood as described with respect to each of decoder models, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

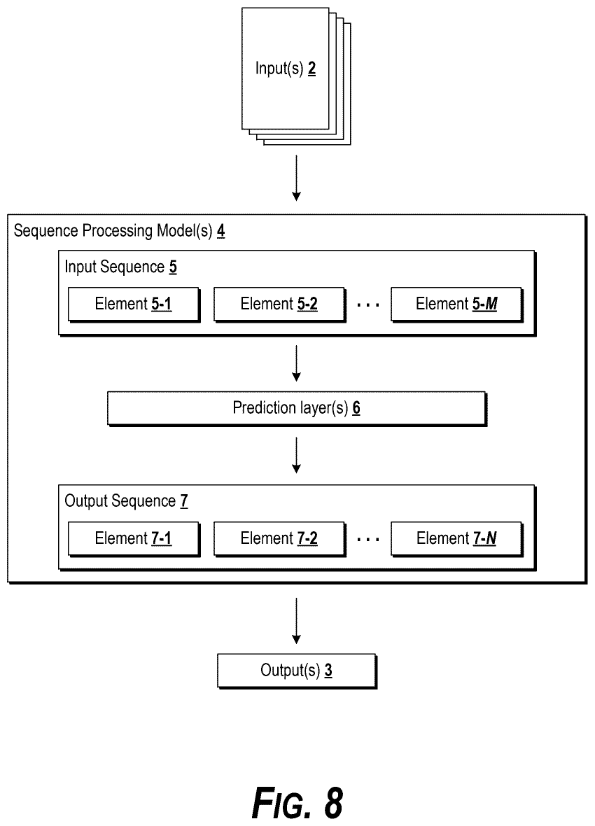

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., AudioLM: a Language Modeling Approach to Audio Generation, arXiv:2209.03143v2 (Jul. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

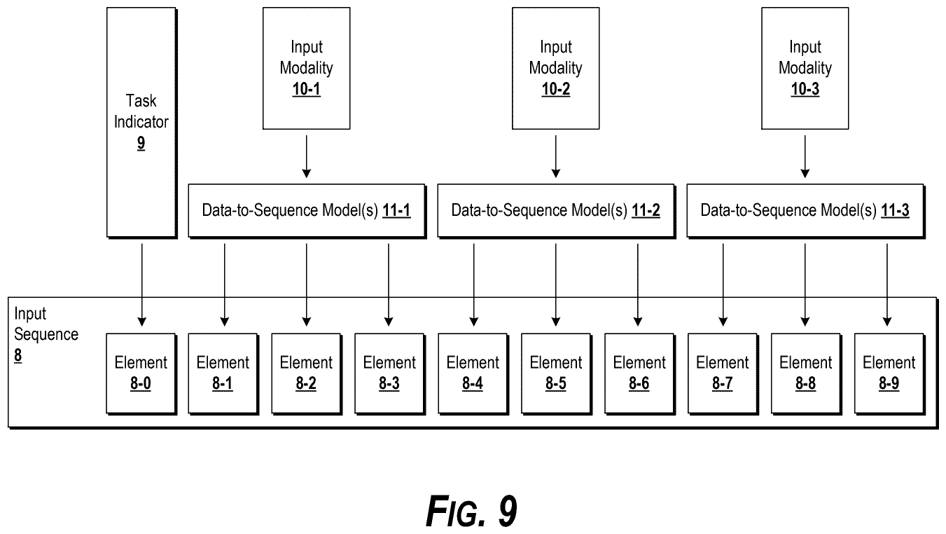

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

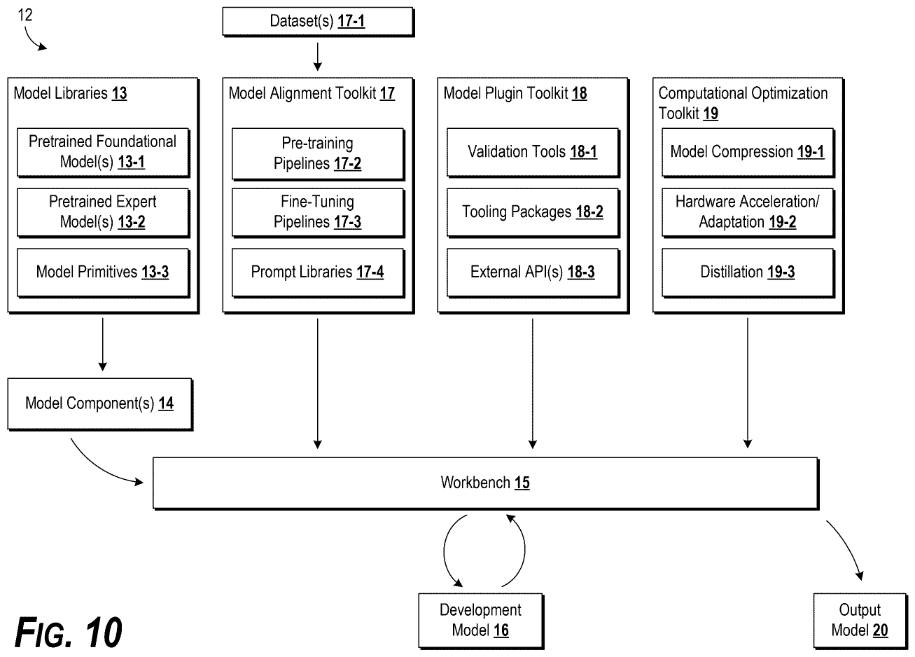

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

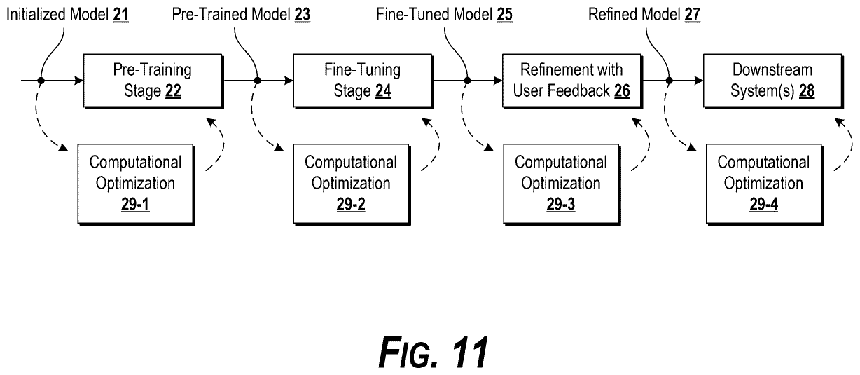

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

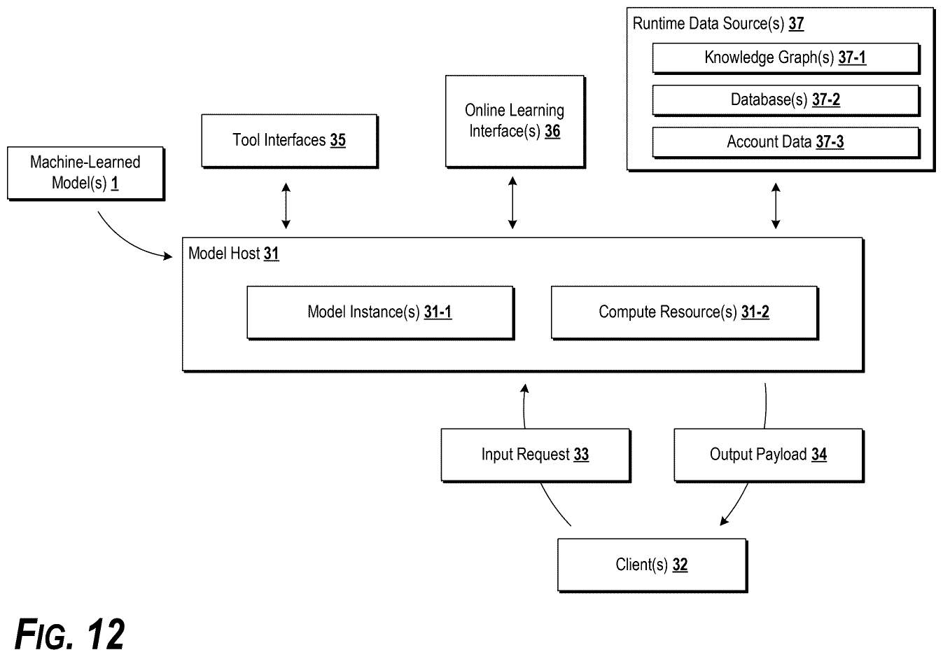

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

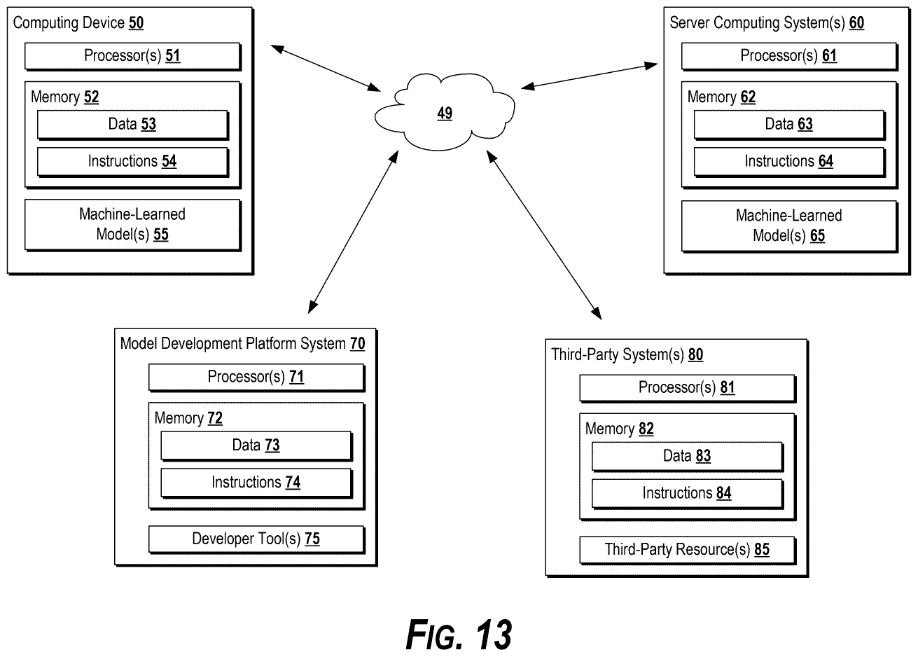

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

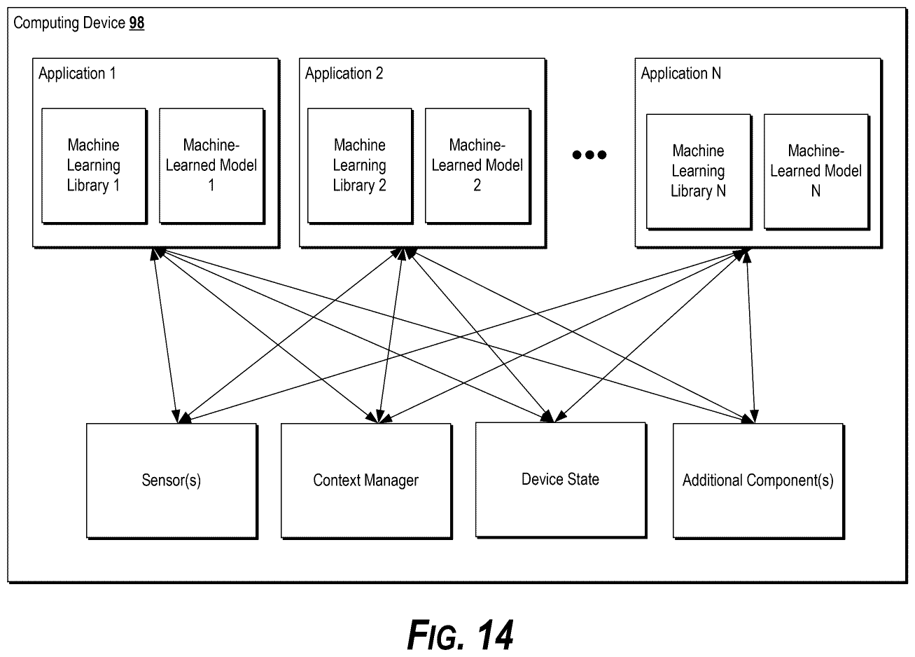

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

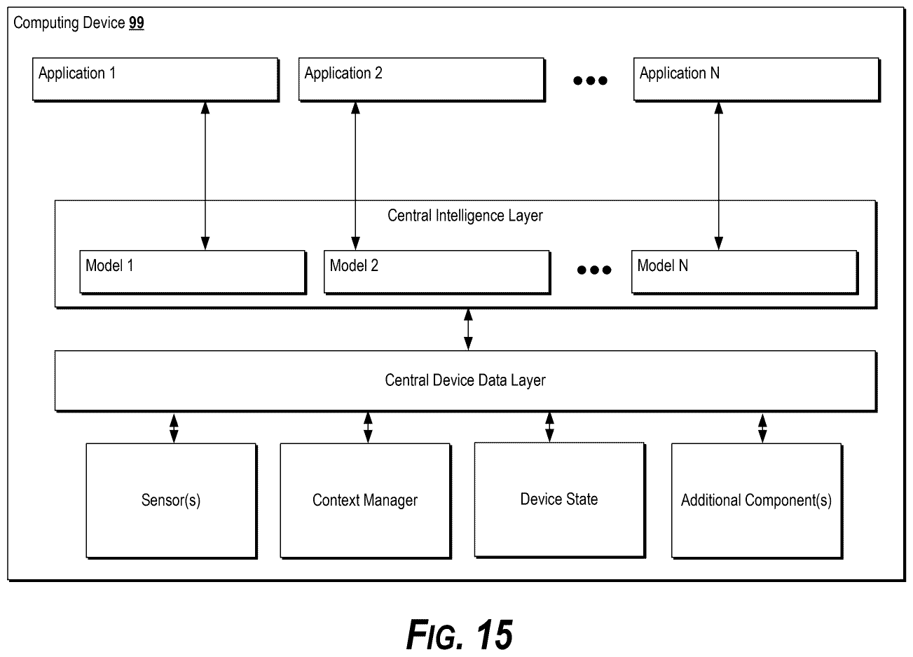

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method comprising:
processing input data using a sequence processing model to generate a first response as an output of the sequence processing model, wherein the first response comprises a first sequence of tokens;
updating, based on the first response, a corpus of output responses;
processing the input data using the sequence processing model to generate an additional response as an additional output of the sequence processing model, wherein:
the additional response comprises an additional sequence of tokens;
the sequence processing model utilizes a sampling method that biases a sampling of the additional sequence of tokens based on a distance metric, wherein the sampling method selects one or more additional tokens that are diverse from tokens contained in the corpus of output responses based on the distance metric; and
the additional output is based on the one or more additional tokens that are diverse from the tokens contained in the corpus of output responses; and
outputting the additional output to a user interface.

2. The computer-implemented method of claim 1, further comprising:
updating, based on the additional response, the corpus of output responses.

3. The computer-implemented method of claim 2, further comprising:
providing the corpus of output responses as the additional output of the sequence processing model.

4. The computer-implemented method of claim 1, wherein the distance metric comprises a Levenshtein distance.

5. The computer-implemented method of claim 1, wherein the sampling method that biases the sampling of the additional sequence of tokens comprises:
applying a penalty to candidate tokens based on the distance metric to modify a probability distribution for the candidate tokens, wherein the modified probability distribution decreases a probability of penalized candidate tokens being included in the additional response.

6. The computer-implemented method of claim 5, wherein the penalized candidate tokens are associated with candidate tokens which fail to satisfy a distance metric threshold, the distance metric threshold indicative of a level of semantic differences between the candidate tokens and the tokens contained in the corpus of output responses.

7. The computer-implemented method of claim 1, wherein the one or more additional tokens that are diverse from tokens contained in the corpus of output responses comprise one or more semantic differences.

8. The computer-implemented method of claim 1, further comprising:
analyzing the corpus of output responses to determine one or more fundamental tokens, the one or more fundamental tokens associated with tokens that impact at least one of (i) a level of meaning or (ii) accuracy of the additional response.

9. The computer-implemented method of claim 8, wherein the tokens are indicative of a probability distribution threshold, wherein the probability distribution threshold is associated with a level of correctness.

10. The computer-implemented method of claim 8, wherein the additional response comprises the one or more fundamental tokens.

11. The computer-implemented method of claim 1, further comprising:
generating another response concurrent to the first response as another output of the sequence processing model, wherein the other response comprises another sequence of tokens; and
updating, based on the other response, the corpus of output responses in real-time.

12. The computer-implemented method of claim 1, wherein the sequence processing model comprises at least one of (i) a large language model (LLM) or (ii) a large multimodal model (LMM).

13. The computer-implemented method of claim 1, wherein the one or more additional tokens comprises text data.

14. The computer-implemented method of claim 1, further comprising training the sequence processing model using the one or more additional tokens that are diverse from the tokens contained in the corpus of output responses.

15. A computing system, comprising:
one or more processors; and
one or more non-transitory, computer-readable media storing instructions that, when implemented, cause the one or more processors to perform operations comprising:
processing input data using a sequence processing model to generate a first response as an output of the sequence processing model, wherein the first response comprises a first sequence of tokens;
updating, based on the first response, a corpus of output responses;
processing the input data using the sequence processing model to generate an additional response as an additional output of the sequence processing model, wherein:
the additional response comprises an additional sequence of tokens;
the sequence processing model utilizes a sampling method that biases a sampling of candidate tokens associated with the additional sequence of tokens based on a distance metric, wherein the sampling method selects one or more additional tokens that are diverse from tokens contained in the corpus of output responses based on the distance metric; and
the additional output is based on the one or more additional tokens that are diverse from the tokens contained in the corpus of output responses; and
outputting the additional output to a user interface.

16. The computing system of claim 15, wherein the operations further comprise:
updating, based on the additional response, the corpus of output responses.

17. The computing system of claim 15, wherein the operations further comprise:
providing the corpus of output responses as the additional output of the sequence processing model.

18. The computing system of claim 17, wherein the distance metric comprises a Levenshtein distance.

19. The computing system of claim 15, wherein the operations further comprise:
analyzing the corpus of output responses to determine one or more fundamental tokens, the one or more fundamental tokens associated with tokens that impact at least one of (i) a level of meaning or (ii) accuracy of the additional response.

20. One or more non-transitory, computer-readable media storing instructions that, when implemented, cause one or more processors to perform operations, the operations comprising:
processing input data using a sequence processing model to generate a first response as an output of the sequence processing model, wherein the first response comprises a first sequence of tokens;
updating, based on the first response, a corpus of output responses;
processing the input data using the sequence processing model to generate an additional response as an additional output of the sequence processing model, wherein:
the additional response comprises an additional sequence of tokens;
the sequence processing model utilizes a sampling method that biases a sampling of candidate tokens associated with the additional sequence of tokens based on a distance metric, wherein the sampling method selects one or more additional tokens that are diverse from tokens contained in the corpus of output responses based on the distance metric; and
the additional output is based on the one or more additional tokens that are diverse from the tokens contained in the corpus of output responses; and
outputting the additional output to a user interface.
